(19) United States
(12) Patent Application Publication
(10) Pub. No.: US 2011/0139375 A1
(43) Pub. Date: Jun. 16, 2011

(54) METHOD AND APPARATUS FOR SEPARATING ADHESIVE TAPE

(76) Inventors: Masayuki Yamamoto, Osaka (JP); Masaru Irie, Kameyama-shi (JP)

(21) Appl. No.: 12/966,011

(22) Filed: Dec. 13, 2010

(30) Foreign Application Priority Data
Dec. 14, 2009 (JP) 2009-282717

(51) Int. Cl. B32B 38/10

(52) U.S. Cl. 156/712; 156/753; 156/930

(57) ABSTRACT

An adhesive tape joined to a wafer is irradiated with ultraviolet rays via diodes. Simultaneously, a heater heats the adhesive tape to a preset temperature. Consequently, an ultraviolet reaction with the diodes and an infrared reaction with the heater may ensure promotion of a polymerization reaction, which results in cure of an adhesive that is not curable with only ultraviolet rays. As a result, an adhesive force of the adhesion tape may sufficiently be reduced. After ultraviolet irradiation via the diodes and heating with the heater, a separation mechanism separates the adhesive tape from the wafer. Therefore, accurate separation may be realized of the adhesive tape joined to the wafer.

### BACKGROUND OF THE INVENTION

1. Field of the Invention

This invention relates to ultraviolet irradiation method and apparatus for separating an ultraviolet curable adhesive tape joined to a semiconductor wafer.

2. Description of the Related Art

Examples of methods for use in thinning a semiconductor wafer (hereinafter, simply referred to as a “wafer”) include a mechanical method such as grinding and polishing or a chemical method such as etching for achieving the wafer of a smaller thickness. Upon thinning of the wafer through these methods, an adhesive tape for protection (hereinafter, simply referred to as a “protective tape”) is joined to a surface of the wafer with a wiring pattern formed thereon. A rear face of the polished wafer with the protective tape joined thereto is adhesively held on a ring frame via an adhesive tape for support (hereinafter, simply referred to as a “supporting adhesive tape”.) Subsequently, the protective tape is separated and removed from the surface of the wafer held on the ring frame.

The following method is known for separating and removing the protective tape. That is, a separation tape is joined to the surface of the protective tape, and then the separation tape is separated. As a result, the separation tape is separated and removed from the surface of the wafer integrally with the protective tape.

Moreover, an ultraviolet curable protective tape is used as the protective tape. The protective tape is irradiated with ultraviolet rays prior to separation, which results in a reduced adhesive force thereof. Examples of devices for irradiation with ultraviolet rays include the following device. That is, the wafer with the protective tape joined thereto is suction-held on a suction table capable of reciprocating along the guide rail. The ultraviolet irradiation device has ultraviolet light emitting diodes that are arranged in rows and columns. The ultraviolet irradiation device arranged in an upper side irradiates the protective tape with ultraviolet rays during reciprocation of the suction table. See Japanese Patent Publication No. 2006-40944A.

Examples also include the following device. That is, the ultraviolet irradiation device for irradiating the protective tape with ultraviolet rays has ultraviolet light emitting diodes that are arranged in rows and columns for irradiation with ultraviolet rays of different wavelength. See Japanese Patent Publication No. 2008-141038A.

The conventional apparatus with such construction has the following drawbacks.

The device described in Japanese Patent Publication No. 2006-40944, however, has the following drawbacks. The protective tape has an adhesive that is not completely cured. The protective tape has difficulty in separation from the wafer. The wafer may be damaged upon separation of the protective tape therefrom. The wafer has a surface having the protective tape separated therefrom with the adhesive remaining.

The following drawbacks still exists also in the device described in Japanese Patent Publication No. 2008-141038. The protective tape has an adhesive that is not completely cured. The protective tape has difficulty in separation from the wafer. The wafer may be damaged upon separation of the protective tape therefrom. The wafer has a surface having the protective tape separated therefrom with the adhesive remaining.

After intensive studies to solve the drawbacks above through repeated experiments and analyses, the inventors have attained the following finding. It has been found that a photo-polymerization initiator as a component having additional reactivity to infrared rays is slightly contained in the ultraviolet curable adhesive that is considered cured only with ultraviolet rays.

### SUMMARY OF THE INVENTION

The invention has been made regarding the state of the art noted above. This invention has one object to provide method and apparatus for separating an ultraviolet curable adhesive tape, including a protective tape and a supporting adhesive tape, from a semiconductor wafer with high accuracy.

This invention discloses a method of separating an ultraviolet curable adhesive tape that is joined to a semiconductor wafer. The method includes the steps of applying ultraviolet rays to the adhesive tape; heating the adhesive tape; and separating the adhesive tape from the semiconductor wafer after the steps of applying ultraviolet rays and heating the adhesive tape.

According to the method, ultraviolet rays are applied to the ultraviolet curable adhesive tape joined to the semiconductor wafer in the step of applying ultraviolet rays. The adhesive tape is heated in the heating step. That is, a polymerization initiator contained in the adhesive that is not completely cured only with ultraviolet rays is reacted through heating, which promotes positive polymerization reaction. Accordingly, curing in the adhesive is promoted, and an adhesive force thereof is sufficiently reduced. Consequently, the adhesive tape may readily be separated from the semiconductor wafer in the separation step. There may be suppressed damages in the semiconductor wafer and remaining of the adhesive on the surface of the wafer. In other words, the protective tape may be separated from the surface of the semiconductor wafer with high accuracy.

The above method may perform the steps of applying ultraviolet rays and heating in the following order. The steps of applying ultraviolet rays and heating the adhesive tape may be performed simultaneously. The step of heating the adhesive tape may be performed after the step of applying ultraviolet rays. The step of applying ultraviolet rays may be performed after the step of heating the adhesive tape.

The heating step in the above method may be as follows. For instance, the adhesive tape may be heated until reaching a polymerization temperature that is determined in accordance with a photo-polymerization initiator remaining in an adhesion layer of the manufactured adhesive tape. Alternatively, the adhesive tape may be heated until reaching a desired value. As the desired value, a varying pattern is determined that is obtained from correlation in variation between a polymerization rate of a photo-polymerization initiator remaining in an adhesion layer of the manufactured adhesive tape and a heating value upon heating of the adhesive tape.

The adhesive tape in the above method may be as follows. That is, the adhesive tape may be a protective tape for protecting a surface of the semiconductor wafer having a circuit pattern formed thereon. Alternatively, the adhesive tape may be a supporting adhesive tape for supporting the semiconductor wafer and a ring frame.

This invention also discloses adhesive tape separating apparatus for separating an ultraviolet curable adhesive tape that is joined to a semiconductor wafer. The apparatus includes a holder for holding the semiconductor wafer; an ultraviolet irradiation unit for irradiating the adhesive tape with ultraviolet rays; a heater for heating the adhesive tape; and a separation mechanism for separating the adhesive tape from the semiconductor wafer after ultraviolet irradiation by use of the ultraviolet irradiation unit and heating by use of the heater.

According to the configuration, the ultraviolet irradiation unit irradiates the adhesive tape with ultraviolet rays, and the heater heats the adhesive tape. Consequently, heating promotes the polymerization reaction positively, which results in cure of the adhesive that is not completely cured with ultraviolet rays. Therefore, the method according to this invention may suitably be realized.

The foregoing apparatus may be configured as follows. For instance, the heater may be embedded in the holder for heating the adhesive tape via the semiconductor wafer held on the holder. Alternatively, the heater may heat the adhesive tape semiconductor wafer held on the holder in a non-contact manner.

The foregoing apparatus may be configured as follows. For instance, the apparatus may have an input unit for inputting a polymerization temperature of the adhesive tape; a measuring device for measuring a temperature of at least one of the adhesive tape heated by use of the heater and the holder; and a controller for controlling an output voltage of the heater so that a measured temperature measured by the measuring device may be equal to the polymerization temperature inputted by the input unit.

The controller in the above apparatus may be controlled as follows. For instance, the output voltage of the heater may be controlled so that the measured temperature measured by the measuring device may be equal to the polymerization temperature preset in accordance with types of photo-polymerization initiators. Moreover, a varying pattern of a polymerization temperature may be determined as a desired value that is obtained from correlation in variation between a polymerization rate of a photo-polymerization initiator and a heating value upon heating of the adhesive tape. The output voltage of the heater may be controlled so that the desired value may be equal to the measured temperature measured by the measuring device. Furthermore, the output voltage of the heater may be controlled within a given heating time of period, whereby the measured temperature by the measuring device is equal to the polymerization temperature inputted by the input unit. The ultraviolet irradiation unit may be controlled as to apply ultraviolet rays within a given irradiation time of period.

Additional features of the invention will be preset forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an overall perspective view of semiconductor wafer mounting apparatus according to Embodiment 1.

FIG. 2 is a front view of an ultraviolet irradiation device.

FIG. 3 is a block diagram showing control of the ultraviolet irradiation device.

FIG. 4 is a perspective view of a mount frame.

FIG. 5 is a schematic view showing operations of a separation mechanism.

FIG. 6 is a flow chart showing a process of separating a protective tape.

FIG. 7 is a front view showing an another ultraviolet irradiation device that constitutes apparatus according to Embodiment 2.

FIG. 8 is a flow chart showing a process of separating a supporting adhesive tape.

FIGS. 9 to 12 are explanatory views each showing operations of separating the supporting adhesive tape.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments preset forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

### Embodiment 1

One embodiment of the present invention is now described below with reference to the drawings.

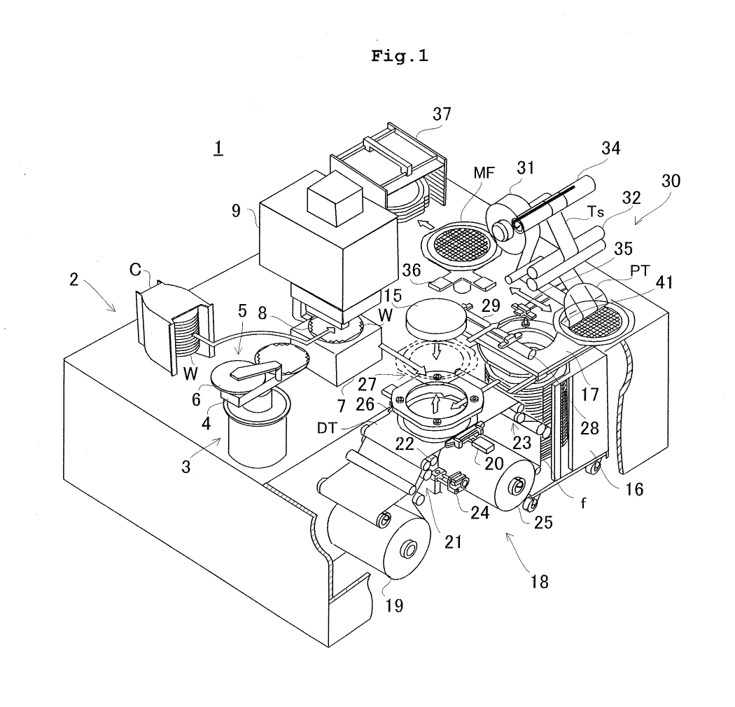

FIG. 1 is a partially cutaway perspective view showing an overall of semiconductor wafer mounting apparatus 1 in one embodiment of this invention.

The semiconductor wafer mounting apparatus 1 includes a wafer supply section 2 with cassettes C placed therein, a wafer transport mechanism 3 with a robot aim 4 and a pressing mechanism 5, an alignment stage 7, an ultraviolet irradiation device 9, a chuck table 15, a ring frame supply section 16, a ring frame transport mechanism 17, a tape processing section 18, a ring frame lifting mechanism 26, a mount frame manufacturing section 27, a first mount frame transport mechanism 29, a separating mechanism 30, a second mount frame transport mechanism 35, a turntable 36, and a mount frame collecting section 37. The wafer supply section 2 has the cassettes C to house a semiconductor wafer (hereinafter, simply referred to as a “wafer W”) in a stack manner to which a back grinding process has been performed. The alignment stage 7 performs alignment of the wafer W. The ultraviolet irradiation device 9 irradiates the wafer W placed on the alignment stage 7 with ultraviolet rays. The chuck table 15 suction-holds the wafer W. The ring frame supply section 16 has a ring frame f housed therein in a stack manner. The ring frame transport mechanism 17 moves to mount the ring frame f onto a supporting adhesive tape DT as a dicing tape (hereinafter, simply referred to as a “dicing tape DT”.) The tape processing section 18 joins the adhesive tape DT to a rear face of the ring frame f. The ring frame lifting mechanism 26 moves vertically the ring frame f with the adhesive tape DT joined thereto. The mount frame manufacturing section 27 manufactures a mount frame MF produced in one piece by joining the wafer W to the ring frame f with the adhesive tape DT joined thereto. The first mount frame transport mechanism 29 transports the manufactured mount frame MF. The separating mechanism 30 separates a protective tape PT joined to a surface of the wafer W. The second mount frame transport mechanism 35 transports the mount frame MF with the protective tape PT separated therefrom with the separation mechanism 30. The turntable 36 turns and transfers the mount frame MF. The mount frame collecting section 37 collects the mount frame MF in a stack manner.

The protective tape PT to be joined to the surface of the wafer W with the circuit pattern formed therein is of an ultraviolet curable type composed of a base material and a photo-polymerization adhesive. Examples of photo-polymerization initiators mixed in the adhesive include an alkylphenon photo-polymerization initiator, an acylphosphine oxide photo-polymerization initiator, a titanocene photo-polymerization initiator, or another new photo-polymerization initiator of unimolecular initiator type or a blend of these initiators. Here, the protective tape PT corresponds to the ultraviolet curable adhesive tape of this invention.

The wafer supplying section 2 includes a cassette table not shown. The wafer W has a circuit pattern surface (hereinafter appropriately referred to as a “surface”) with the protective tape PT joined thereto. The cassette C with the wafers W housed therein in a stack manner is placed on the cassette table. Here, each of the wafers W is kept in a horizontal attitude with the circuit surface thereof directed upward.

The wafer transport mechanism 3 turns and moves vertically with a drive mechanism not shown. Specifically, the wafer transport mechanism 3 performs positioning of a wafer holder of the robot arm 4 and a pressure plate 6 provided in the pressing mechanism 5, mentioned later, and transfers the wafer W from the cassette C to the alignment stage 7.

The robot arm 4 of the wafer transport mechanism 3 has at its tip end the wafer holder in a horseshoe shape, not shown. The robot arm 4 moves the wafer holder forward and backward between the wafers W housed in the cassette C in a stack manner. Here, the wafer holder at the tip end of the robot arm has a vacuum suction hole to perform vacuum suction on the rear face of the wafer W.

The pressing mechanism 5 of the wafer transport mechanism 3 has at its end the circular pressure plate 6 of an approximately similar shape to the wafer W. The robot arm 4 moves backward and forward such that the pressure plate 6 moves above the wafer W placed on the alignment stage 7.

The pressing mechanism 5 operates in poor suction of the wafer W upon placing of the wafer W on the holding table 8 of the alignment stage 7. Specifically, when the wafer W cannot be suction-held due to warping thereof, the pressure plate 6 presses the surface of the wafer W to correct the warping, allowing the wafer to be planar. The holding table 8 performs vacuum suction on the rear face of the wafer W under this state.

The alignment stage 7 performs alignment of the placed wafer W based on an orientation mark or a notch formed at an outer periphery of the wafer W. The alignment stage 7 includes the holding table 8 to cover the entire rear face of the wafer W for performing vacuum suction, and a motor M to turn the holding table 8.

The alignment stage 7 may move so as to transport the wafer W in a suction-held state from an initial position to an intermediate position. In the initial position, the wafer W is placed to perform alignment. The intermediate position is between the chuck table 15 and the ring frame lifting mechanism 26 above the tape processing section 18. In other words, the alignment stage 7 transports the wafer W to the subsequent process with the warping thereof being corrected to be planar.

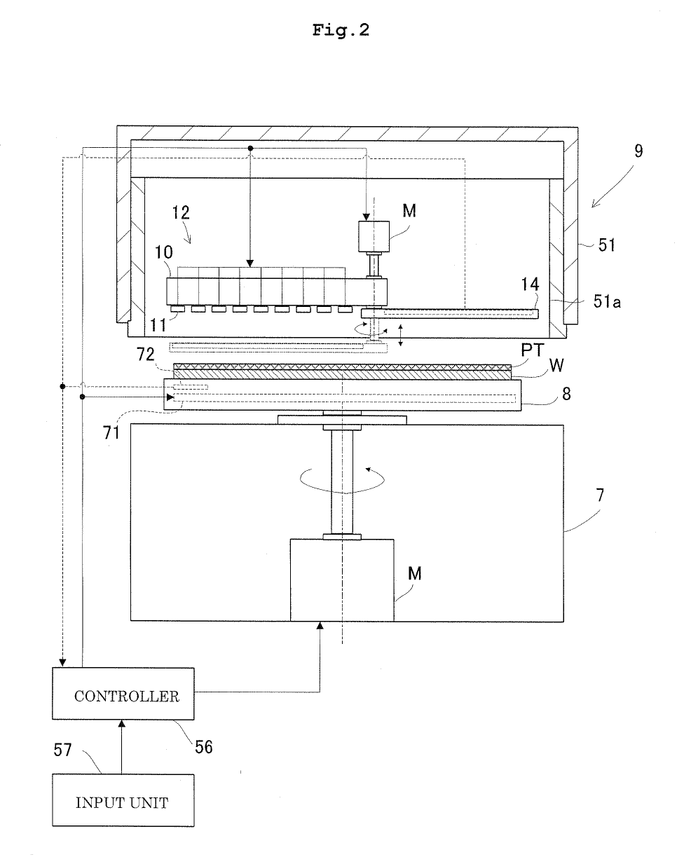

As shown in FIG. 2, the holding table 8 has a heater 71 embedded therein for heating the protective tape PT via the placed wafer W. The holding table 8 has a temperature sensor 72 for determining a temperature of the heater 71. The temperature measured with the temperature sensor 72 is sent to a controller 56, mentioned later. Here, the heater 71 corresponds to the heater of this invention.

An ultraviolet irradiation device 9 is provided above the alignment stage 7 in the initial position. Specifically, the ultraviolet irradiation device 9 includes an ultraviolet irradiation unit 12, an illumination sensor 14, and the controller 56. The ultraviolet irradiation unit 12 has ultraviolet light emitting diodes (hereinafter simply referred to as “diodes”) 11 arranged at given intervals in one dimensional array along a support plate 10 extending outwardly from a base on a center side of the alignment stage 7. The illumination sensor 14 moves to a position below the ultraviolet irradiation unit 12 to measure ultraviolet illuminance. The controller 56 controls heating of the heater 71 and irradiation of the diodes 11.

The ultraviolet irradiation device 9 has a box shielding wall 51 that is open downward. The shielding wall 51 has a cylindrical shielding wall 51 a provided at a lower region thereof that is capable of moving vertically. Specifically, in the process of ultraviolet irradiation via the diodes 11, the movable shielding wall 51 a moves downward until it contacts the upper surface of the alignment stage 7. Accordingly, the protective tape PT on the surface of the wafer W may be irradiated with ultraviolet rays from the diodes 11 with no leakage of ultraviolet rays outside with the movable shielding wall 51a.

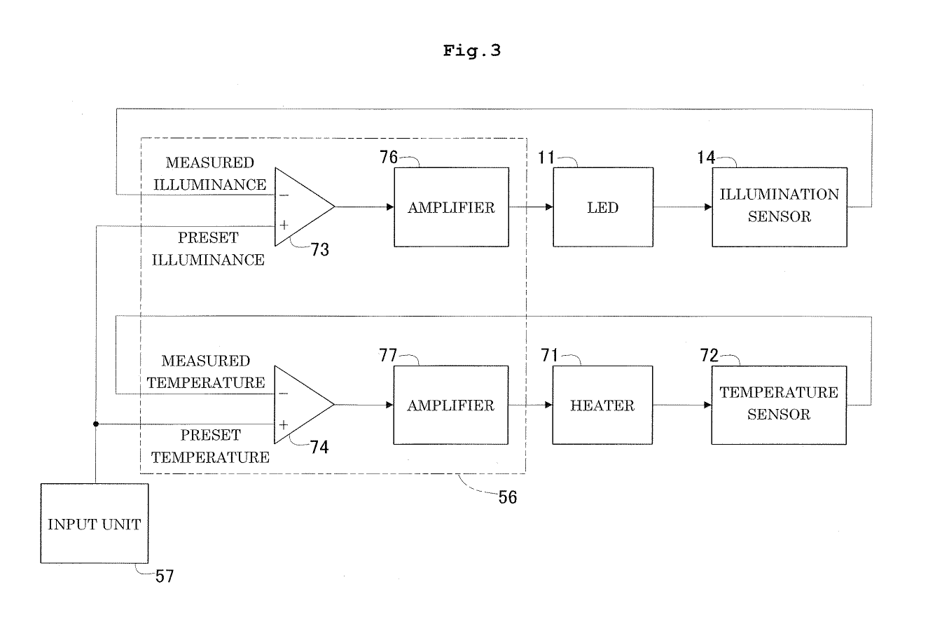

Next, description will be given of the controller 56 with reference to FIG. 3. The controller 56 has comparators 73 and 74, and amplifiers 76 and 77. The comparators 73 and 74 perform feedback control of the temperature of the heater 71 and illuminance of each diode 11. The amplifiers 76 and 77 adjust the output voltages of each diode 11 and the heater 71. The comparator 73 compares the measured illuminance with the preset illuminance. The measured illuminance is determined with the illumination sensor 14 and is applied to a signal input side of the comparator 73. The preset illuminance is set with the input unit 57 and is applied to a reference voltage side of the comparator 73. The amplifier 76 adjusts the output voltage in accordance with the comparison results for varying intensity of ultraviolet rays. That is, uniform illuminance may be achieved on the surface of the protective tape PT through adjustment of the illuminance.

The comparator 74 compares the measured temperature with the preset temperature. The measured temperature is determined with the temperature sensor 72 and is applied to a signal input side of the comparator 74. The preset temperature is set with the input unit 57 and is applied to a reference voltage side of the comparator 74. The amplifier 77 adjusts the output voltage in accordance with the comparison results for varying output of the heater 71, which realizes control of the temperature of the heater 71. In other words, when the diodes 11 irradiate the protective tape PT with ultraviolet rays, the heater 71 may heat the protective tape PT to an optimal curing temperature.

Reference is again made to FIG. 1. The chuck table 15 has a circular shape approximately similar to the wafer W so as to cover the surface of the wafer W for performing vacuum suction. The chuck table 15 moves vertically from a standby position above the tape processing section 18 to a position where the wafer W is joined to the ring frame £ The chuck table 15 contacts and suction-holds the wafer W held in a planar state with the warping thereof corrected by the holding table 8.

The chuck table 15 is received in an opening of the ring frame lifting mechanism 26, to suction-hold the ring frame f with the adhesive tape DT joined to the rear face thereof. Thereafter, the wafer W is moved downward to a position adjacent the adhesive tape DT on a center portion of the ring frame f. Here, a holding mechanism, not shown, holds the chuck table 15 and ring frame lifting mechanism 26.

The body of the device houses the wagon-like ring frame supply unit 16 having pulleys provided on the bottom thereof. The ring frame supply unit 16 has an opening on an upper side thereof to slidingly move upward and feed out the ring frame f housed therein in a stack manner.

The ring frame transport mechanism 17 performs vacuum suction on every one ring frame f housed in the ring frame supply unit 16 in turn from the top, and transports the ring frame f to an alignment stage not shown and a joining position of the adhesive tape DT, in turn. The ring frame transport mechanism 17 serves as a holding mechanism to hold the ring frame fin the joining position of the adhesive tape DT when joining the adhesive tape DT.

The tape processing section 18 includes a tape supply unit 19, a tension mechanism 20, a joining unit 21, a cutter mechanism 24, a separating unit 23, and a tape collecting section 25. The tape supply unit 19 supplies the adhesive tape DT. The tension mechanism 20 applies tension to the adhesive tape DT. The joining unit 21 joins the adhesive tape DT to the ring frame f. The cutter mechanism 24 cuts the adhesive tape DT joined to the ring frame f. The separating unit 23 separates an unnecessary tape cut with the cutter mechanism 24 from the ring frame f. The tape collecting section 25 collects remainder of the cut unnecessary tape.

The tension mechanism 20 sandwiches the adhesive tape DT on opposite ends in a width-direction to apply tension to the adhesive tape DT in a tape width direction. When a soft adhesive tape DT is used, tension applied to a tape supply direction may cause occurrence of a longitudinal wrinkle on the surface of the adhesive tape DT along the tape supply direction. In order to avoid the longitudinal wrinkle so as to join the adhesive tape DT uniformly to the ring frame f the tension mechanism 20 applies tension on the opposite ends in the tape width direction.

The joining unit 21 is placed obliquely downwardly from the ring frame f, above the adhesive tape DT or in the standby position. The joining unit 21 has a joining roller 22. The ring frame transport mechanism 17 holds to transport the ring frame f into the joining position of the adhesive tape DT. Subsequently, the tape supply unit 19 starts to supply the adhesive tape DT, and simultaneously the joining roller 22 moves to a joining start position on the right of the tape supply direction.

Subsequently, the joining roller 22 in the joining start position moves upward and rolls from the joining start position toward the standby position, thereby joining the adhesive tape DT to the ring frame f while pressing.

The separation unit 23 separates the unnecessary portion of the adhesive tape DT cut with the cutter mechanism 24 from the ring frame f. Specifically, after joining the adhesive tape DT to the ring frame f and cutting the adhesive tape DT, the tension mechanism 20 releases holding of the adhesive tape DT. Subsequently, the separation unit 23 moves toward the tape supply unit 19 on the ring frame f, thereby separating the cut unnecessary adhesive tape DT.

The cutter mechanism 24 is placed below the adhesive tape DT joined to the ring frame f. When the joining unit 21 joins the adhesive tape DT to the ring frame f, the tension mechanism 20 releases holding of the adhesive tape DT, and the cutter mechanism 24 moves upward. The cutter mechanism 24 after moving upward cuts the adhesive tape DT along the ring frame f.

The ring frame lifting mechanism 26 is placed in the standby position above the joining position of the adhesive tape DT to the ring frame f. After joining of the adhesive tape DT to the ring frame f, the ring frame lifting mechanism 26 moves downward to suction-hold the ring frame f. At this time, the ring frame transport mechanism 17 holding the ring frame f returns to its initial position above the ring frame supply unit 16.

After suction-holding the ring frame f, the ring frame lifting mechanism 26 moves upward to a position of joining the wafer W. At this time, the chuck table 15 holding the wafer W also moves downward to the position of joining the wafer W.

The mount frame manufacturing section 27 has a joining roller 28 with an outer peripheral surface that is elastically deformable. The joining roller 28 rolls on a non-adhesive surface of the adhesive tape DT joined to the rear face of the ring frame f while pressing.

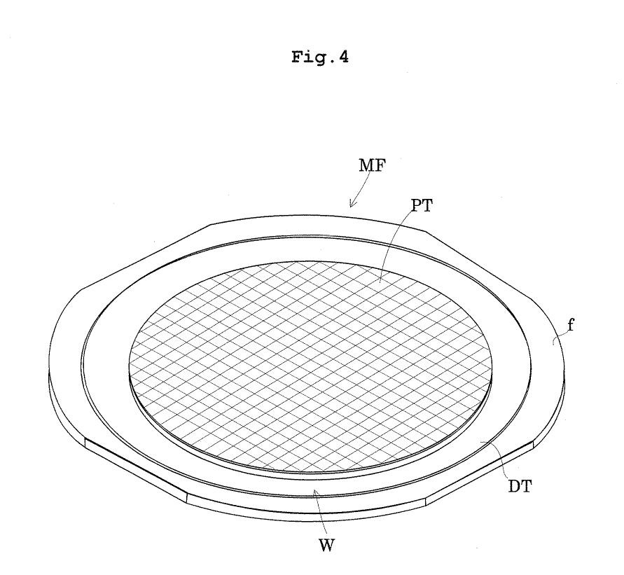

As shown in FIG. 4, the mount frame MF has the ring frame f, the wafer W, and the adhesive tape DT. Here, the wafer W is placed on a center portion of the ring frame f and subject to a back grinding process with the protective tape PT joined thereto. The adhesive tape DT is joined to the rear faces of the ring frame f and the wafer W for supporting the wafer W upon a dicing process.

Reference is made again to FIG. 1. The first mount frame transport mechanism 29 performs vacuum suction on the mount frame MF that the ring frame f is formed in one piece with the wafer W, and moves to mount the mount frame MF onto the separation mechanism 30.

The separating mechanism 30 includes a separation table, a tape supply section 31, a separating unit 32, and a tape collecting section 34. The separation table moves the wafer W mounted thereon. The tape supply section 31 supplies a separation tape Ts. The separation unit 32 joins and separates the separation tape Ts. The tape collecting section 34 collects the separated separation tape Ts and the protective tape PT.

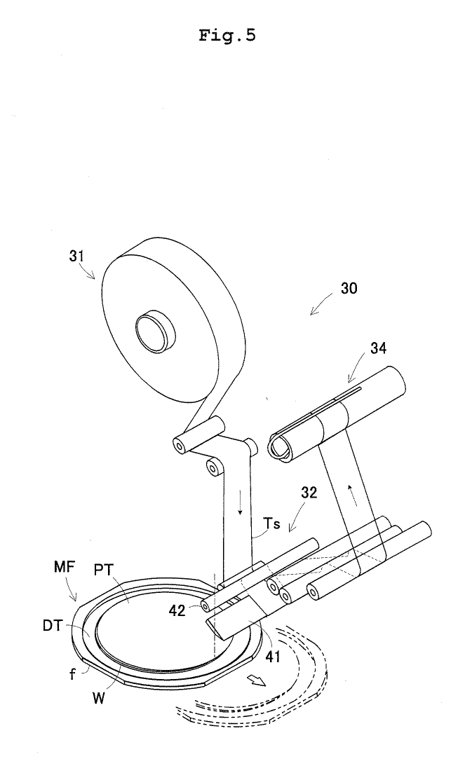

As shown in FIG. 5, the tape supplying unit 31 guides and supplies the separation tape Ts fed out from an original master roll to a lower side of the separation unit 32. The tape collecting section 34 guides upward the separation tape Ts fed out from the separation unit 32 so as to wind up and collect the separation tape Ts.

The separation unit 32 has a sharp edge member 41 and a guide roller 42. The edge member 41 serves as joining and separating members of the separation tape Ts. The guide roller 42 guides the separation tape Ts folded back at a tip end of the edge member 41 toward the tape collecting section 34. The edge member 41 moves downward and the mount frame MF moves in a feeding direction of the separation tape Ts. Then, the separation tape Ts folded back at the end of the edge member 41 is pressed to contact the end of the wafer W, thereby being joined to each other. The protective tape PT is separated from the wafer W as the separation tape Ts is wound up and collected in the tape collecting section 34.

Reference is made again to FIG. 1. The second mount frame transport mechanism 35 performs vacuum suction on the mount frame MF fed out from the separating mechanism 30, and moves to mount it onto the turntable 36.

The turntable 36 aligns the mount frame MF, and houses it in the mount frame collecting section 37. Specifically, the second mount frames transport mechanism 35 places the mount frame MF on the turntable 36, and then the turntable 36 aligns the mount frame MF based on an orientation mark of the wafer W or a positioning contour of the ring frame f. The turntable 36 turns so as to change a direction in which the mount frame MF is housed in the mount frame collecting section 37. When the direction for housing the mount frame is fixed, the turntable 36 presses out the mount frame MF with a pusher not shown to house the mount frame MF in the mount frame collecting section 37.

The mount frame collecting section 37 is placed on a mount table capable of moving vertically. Specifically, vertical movement of the mount table allows the mount frame MF pushed out with the pusher to be housed on any sections in the mount frame collecting section 37.

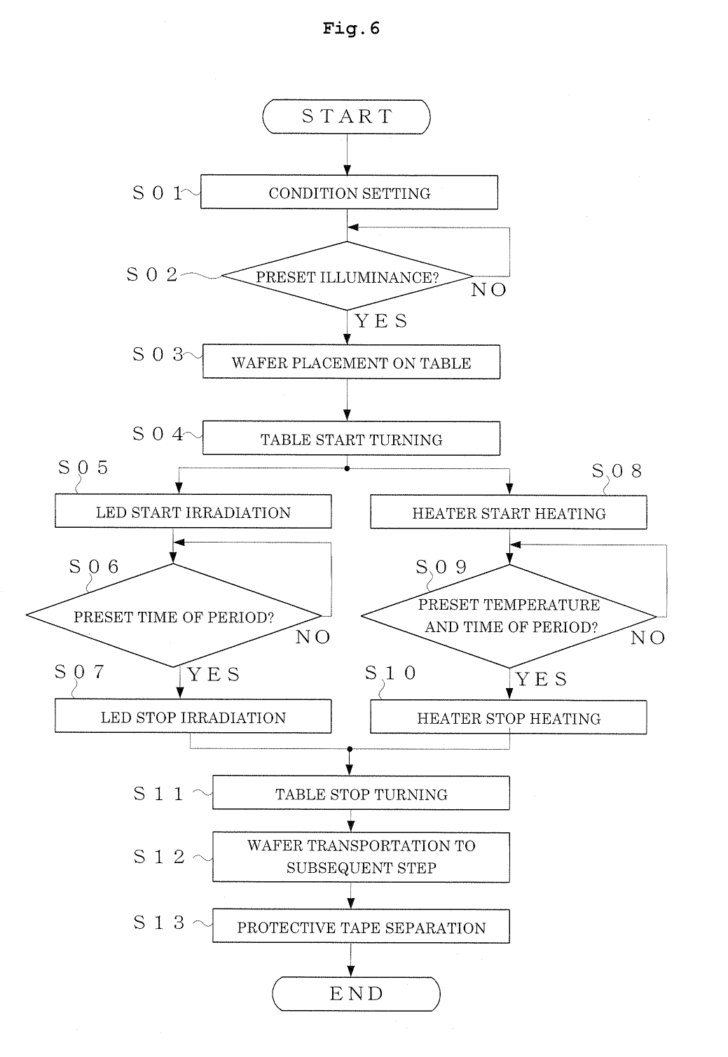

Next, description will be given to a process of separating the protective tape according to the apparatus in this embodiment with reference to FIG. 6. In addition, description will be further given of operations of the apparatus in this embodiment with reference to FIGS. 1 to 5.

<Step S01>

Firstly, settings of each mechanism in the semiconductor wafer mounting apparatus 1 are inputted into the controller 56 via the input unit 57 such as an operating panel. For instance, in this embodiment, input is performed of such as an output voltage of the diodes 11, a polymerization temperature of the protective tape PT, an irradiation time of period of the diodes 11, and a heating time of period of the heater 71. Simultaneously, as in FIG. 2, a drive mechanism of the illumination sensor 14 operates to move into a measurement position shown by long dashed double-short dashed lines.

A varying pattern on the polymerization temperature of the protective tape PT is determined from the correlation in variation between a rate of polymerization obtained through experiments and a heating value at that time. The varying pattern is set as a desired value. Here, the polymerization temperature is set in accordance with the initiator.

<Step S02>

When movement of the illumination sensor 14 is completed, the ultraviolet irradiation unit 12 operates to perform an initial measurement while the holding table 8 turns. The result of the measurement detected by the illumination sensor 14 facing to each of the diodes 11 is transmitted to the controller 56. Where the measured result does not reach the preset illuminance, an output voltage is adjusted. Where the measured result reaches the preset illuminance, measurement is completed to proceed to the subsequent step. After completion of the measurement, the illumination sensor 14 returns to its upper standby position, shown by solid lines, that is apart from the measurement position.

<Step S03>

Upon fixing of ultraviolet irradiation conditions, the robot arm 4 operates so that the wafer holder is inserted between the stacked wafers W in the cassette C. The wafer W is suction-held on the rear face thereof, and pulled out for every one sheet. The pulled out wafer W is transported to the alignment stage 7.

The robot arm 4 places the wafer W on the holding table 8 to suction-hold the rear face of the wafer W. In this state, a pressure gauge, not shown, measures a level where the wafer W is suction-held. A comparison is made of the measurement result and the predetermined reference value in relation to a pressure value in a normal operation.

When poor suction holding is detected from the result of the comparison, the pressure plate 6 presses a surface of the wafer W. Consequently, the wafer W in a planar state with corrected warping may be suction-held. In addition, the wafer W is aligned based on the orientation mark or the notch.

<Step S04>

The holding table 8 turns upon detection of the orientation mark or the notch of the wafer W.

<Step S05>

The ultraviolet irradiation unit 12 provided with the diodes 11 irradiates the protective tape PT with ultraviolet rays upon turning of the holding table 8.

<Step S06>

The controller 56 determines whether or not ultraviolet rays have been applied to the protective tape PT for a preset period. Where ultraviolet rays have been applied for less than the preset period, further ultraviolet ray irradiation is conducted. Where ultraviolet rays have been applied for the preset period, the operation proceeds to the subsequent step.

<Step S07>

The controller 56 stops ultraviolet irradiation via the diode 11.

<Step S08>

In Step S05, the protective tape PT is irradiated with ultraviolet rays via the diodes 11, and simultaneously the controller 56 starts heating with the heater 71 embedded in the holding table 8 of the alignment stage 7. Accordingly, the protective tape PT is heated via the wafer W placed thereon.

<Step S09>

The controller 56 determines whether or not a temperature of the heated heater 71 reaches a preset temperature. The controller 56 adjusts the output voltage of the heater 71 with the amplifier 77 within a preset period so that the detected temperature conforms to the varying pattern on the polymerization temperature.

Where the detected time is less than the preset period, the controller 56 continues adjusting of heating with the heater 71. Where the detected time reaches the preset period, the operation proceeds to the subsequent step.

<Step S10>

Upon reaching to the preset period, the controller 56 stops heating with the heater 71.

<Step S11>

A motor M of the ultraviolet irradiation device 9 stops driving. The holding table 8 of the alignment stage 7 stops. At this time, the alignment process is also completed.

<Step S12>

The wafer W is transported, along with the alignment stage 7, to the mount frame manufacturing unit 27 at the subsequent step while being suction-held on the holding table 8.

When the alignment stage 7 is set standby in a predetermined position, the chuck table 15 located above the alignment stage 7 moves downward. The wafer W is received on the chuck table 15 in a planar state with the warping thereof being corrected.

The ring frame transport mechanism 17 performs vacuum suction on every ring frame f from the top that is housed in the ring frame supplying unit 16 in a stack manner, and then pulls it out.

The ring frame transport mechanism 17 holds and moves the ring frame f into the joining position of the adhesive tape DT, and then the tape supply section 19 starts to supply the adhesive tape DT. Simultaneously, the joining roller 22 moves into a joining start position.

When the joining roller 22 reaches into the joining start position, the tension mechanism 20 holds the opposite ends of the adhesive tape DT in the tape width direction, thereby applying tension to the adhesive tape DT in the tape width direction.

Next, the joining roller 22 moves upward to press and join the adhesive tape DT onto the end of the ring frame f. Here, the joining roller 22 rolls while pressing the non-adhesive surface of the adhesive tape DT, thereby joining the adhesive tape DT to the ring frame f. When the joining roller 22 reaches at its joining termination position, the tension mechanism 20 releases holding of the adhesive tape DT.

Simultaneously, the cutter mechanism 24 moves upward to cut the adhesive tape DT along the ring frame f. Upon completion of cutting the adhesive tape DT, the separation unit 23 moves toward the tape supply section 19, thereby separating the unnecessary adhesive tape DT.

Subsequently, the tape supply section 19 operates to feed out the adhesive tape DT while feeding out the unnecessary tape to the tape collecting section 25. In this state, the joining roller 22 moves into the joining start position so as to join the adhesive tape DT to another ring frame f.

The ring frame lifting mechanism 26 moves upward while suction holding a frame portion of the ring frame f with the adhesive tape DT joined thereto. Here, the chuck table 15 also moves downward. That is, the chuck table 15 and the ring frame lifting mechanism 26 each move into the joining position of the wafer W.

Upon reaching at a predetermined position, each of the chuck table 15 and the ring frame lifting mechanism 26 is held with a holding mechanism, not shown. Subsequently, the joining roller 28 moves into a joining start position of the adhesive tape DT. The joining roller 28 rolls while pressing the non-adhesive surface of the adhesive tape DT joined to the rear face of the ring frame f, thereby joining the adhesive tape DT to the wafer W. Consequently, the mount frame MF may be manufactured that the ring frame f and the wafer W are formed in one piece.

After manufacturing of the mount frame MF, the chuck table 15 and the ring frame vertically moving mechanism 26 move upward. The holding table not shown also moves below the mount frame MF and places it. The first mount frame transport mechanism 29 suction-holds the placed mount frame MF, and moves to place the mount frame MF onto the separation table 38.

<Step S13>

The separation table with the mount frame MF placed thereon moves forward below the separation unit 32 as shown in FIG. 5. A light sensor detects a front edge of the protective tape PT with this movement. A pulse motor controls a position of the separation table such that the separation table moves forward from the detected position by a distance determined in advance from the light sensor to the tip end of the edge member 41. Here, the separation table once stops forward movement. Specifically, the separation table once stops forward movement automatically upon reaching of the front edge of the protective tape PT at a position below the tip end of the edge member 41.

Once the separation table stops, the pulse motor operates to control the movable table to move downward such that the edge member 41 moves downward with the separation tape Ts supplied from the tape supply unit 31 being wounded thereon. That is, the separation tape Ts is joined to the front end surface of the protective tape PT at a given pressure while being pushed with the tip end of the edge member 41.

When joining of the separation tape Ts to the front end of the protective tape PT is completed, the separation table starts forward movement again while the edge member 41 presses the separation tape Ts against the protective tape PT. Moreover, the separation tape Ts is wound up to the tape collecting section 34 at a speed synchronized to a traveling speed of the separation table. In this way, the edge member 41 joins the separation tape Ts to the protective tape PT on the surface of the wafer W while pressing. Simultaneously, the edge member 41 separates the protective tape PT from the surface of the wafer W together with the joined separation tape Ts while separating the separation tape Ts.

The pulse motor operates to control the edge member 41 so as to move by a distance corresponding to a diameter of the wafer from a separation tape joining position where the edge member 41 moves downward. Thereafter, upward movement of the edge member 41 is controlled, and the separation unit 32 returns to its initial state. Specifically, when the edge member 41 reaches into the rear edge of the protective tape PT and completely separates the protective tape PT from the surface of the wafer W, the edge member 41 moves upward and the separation unit 32 returns to its initial state.

After the protective tape PT is separated from the mount frame MF, the separation table moves the mount frame MF to the standby position of the second mount frame transport mechanism 35.

Subsequently, the second mount frame transport mechanism 35 moves to place the mount frame MF fed out from the separation mechanism 30 onto the turntable 36. The placed mount frame MF is aligned using the orientation mark or the notch, and a direction of the mount frame MF to be housed is adjusted. After performing alignment of the mount frame MF and determination in the direction thereof to be housed, a pusher pushes out the mount frame MF to house it in the mount frame collecting section 37.

As noted above, the protective tape PT joined to the wafer W is irradiated with ultraviolet rays via the diodes 11, and simultaneously is heated up to the preset temperature with the heater 71. Specifically, a heating treatment is performed to the protective tape PT with the heater 71 in addition to an ultraviolet irradiation treatment via the diodes 11. Consequently, a polymerization reaction of the polymerization initiator may positively be promoted that is not curable with only ultraviolet rays, which results in cure of the adhesive. As a result, an adhesive force of the protective tape PT may sufficiently be reduced. The separation mechanism 30 separates the protective tape PT from the wafer W after the ultraviolet irradiation treatment by the diodes 11 and the heat treatment with the heater 71. Consequently, the separation mechanism 30 may accurately separate the protective tape PT from the surface of the wafer while suppressing damages in the semiconductor wafer that occurs due to an uncured adhesive and remaining of the adhesive on the surface of the wafer W.

### Embodiment 2

Next, Embodiment 2 of this invention will be described in detail hereinafter with reference to the drawings.

Here in this embodiment, description will be given of a case as one example where the mount frame MF is irradiated with ultraviolet rays and heated. In this exemplary embodiment, the adhesive tape DT is an ultraviolet curable adhesive tape, which is similar to the protective tape PT. Elements identical to those of Embodiment 1 are labeled with the same reference numbers, and redundant descriptions are to be omitted.

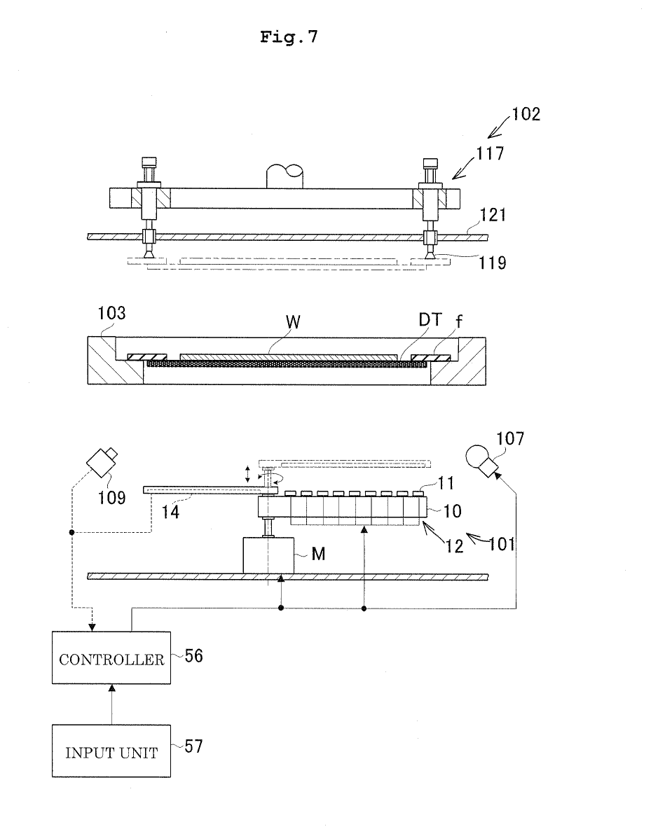

FIG. 7 shows a schematic configuration of an ultraviolet irradiation device that irradiates the adhesive tape DT with ultraviolet rays and heats the adhesive tape DT.

The ultraviolet irradiation device of this embodiment has a workpiece receiving section not shown, an ultraviolet irradiation treatment section 101, a controller 56, a workpiece ejection section not shown, a traversing mechanism 102, and a shielding plate 121. The work receiving section receives a mount frame MF to which a dicing treatment is performed with a dicing device, not shown, on an upper side. The ultraviolet irradiation treating section 101 irradiates with ultraviolet rays an adhesive tape DT joined to a rear face of the mount frame MF transported from the workpiece receiving section. The controller 56 controls ultraviolet irradiation and infrared radiation to the adhesive tape DT. The workpiece ejection section transports the mount frame MF subject to ultraviolet irradiation treatment towards a die-bonding device, not shown, on an lower side. The traversing mechanism 102 suction-holds and transports the mount frame MF from the workpiece receiving section to the ultraviolet irradiation treatment section 101, and from the ultraviolet irradiation treatment section 101 to the workpiece ejection section. The shielding plate 121 blocks a treatment room where the wafer W and the mount frame MF are placed upon replacement of the treatment room by nitrogen gas at the time of ultraviolet irradiation. Here, the adhesive tape DT corresponds to the ultraviolet curable adhesive tape.

The ultraviolet irradiation treatment section 101 has a support board 103 of a ring shape, diodes 11, an infrared lamp 107, and an infrared camera 109. The support board 103 receives a ring frame f of the mount frame MF. The diodes 11, located below the support board 103, irradiate with an ultraviolet rays the adhesive tape DT joined to an under surface of the mount frame MF. The infrared lamp 107 irradiates the adhesive tape DT with infrared rays. The infrared camera 109 detects a temperature of the adhesive tape DT to which infrared rays are applied. The infrared camera 109 detects variations in temperature on a surface of the adhesive tape DT with an infrared thermography.

In the ultraviolet irradiation treatment section 101, the ultraviolet irradiation unit 12, the motor M, and the illumination sensor 14 are coaxially arranged. The ultraviolet irradiation unit 12 has the diodes 11 arranged at given intervals in one dimensional array along a support plate 10 extending outwardly from a center portion of the support board 103. The motor M turns the ultraviolet irradiation unit 12. The illumination sensor 14 moves to an upper position so as to face to the ultraviolet irradiation unit 12 and measures ultraviolet illuminance.

The traversing mechanism 102 has a guide rail, not shown, and a movable frame, not shown. The guide rail is arranged over the workpiece receiving section, the ultraviolet irradiation treatment section 101, and the workpiece ejection section. The movable frame may move forward and backward along the guide rail. The movable frame has a workpiece suction mechanism 117 coupled thereto that is capable of moving vertically. The workpiece suction mechanism 117 has a suction pad 119 provided therein for suction holding the ring frame f of the mount frame MF.

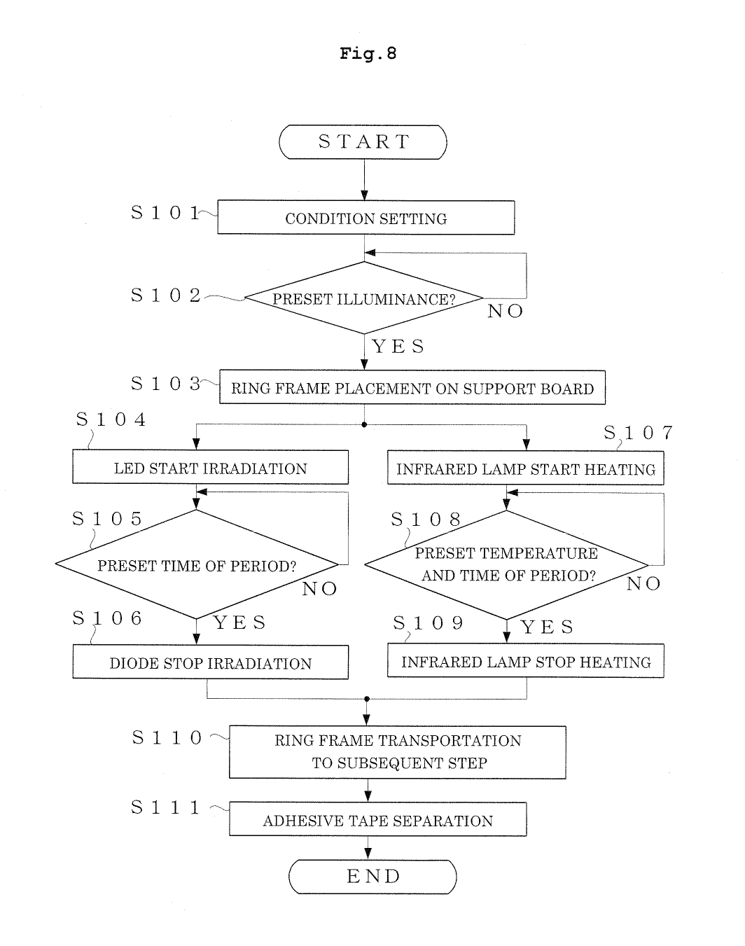

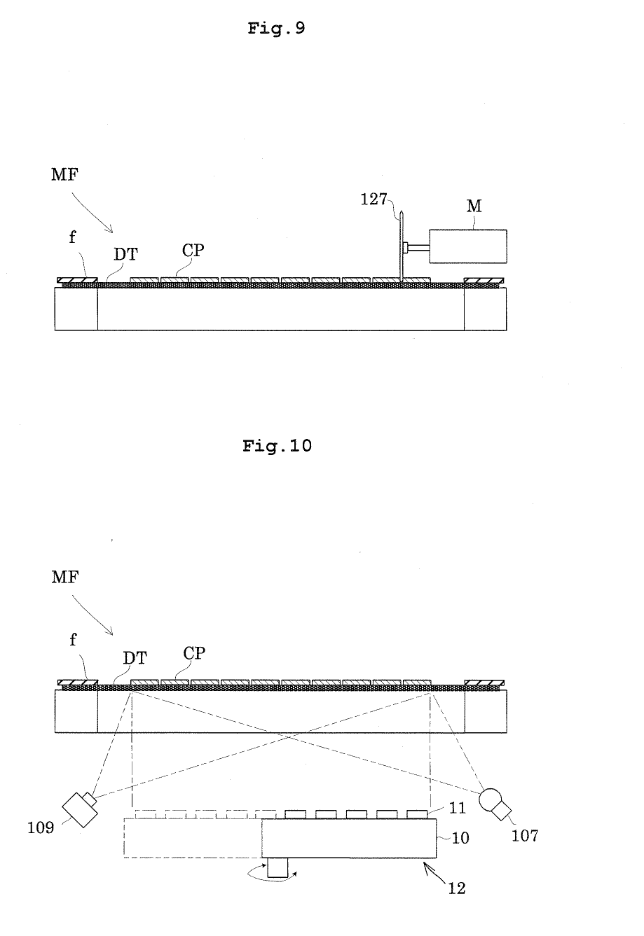

Next, description will be given of an adhesive tape separation process according to Embodiment 2 with reference to FIG. 8. Moreover, operations of the exemplary apparatus will be described with reference to FIGS. 7 and 9 to 12. In this embodiment, a dicing process is performed prior to an ultraviolet irradiation treatment and a heating treatment in the ultraviolet irradiation device 101. Specifically, as shown in FIG. 9, the motor M drives to turn a blade 127. The blade 127 cuts the wafer W into chips CP.

<Step S101>

Firstly, as shown in FIG. 7, settings of each mechanism in the ultraviolet irradiation device are inputted into the controller 56 via the input unit 57 such as an operating panel. For instance, in this embodiment, input is performed of such as illuminance of the diodes 11, a polymerization temperature of the adhesive tape DT, an irradiation time of period of the diodes 11, and a heating time of period of the infrared lamp 107. Simultaneously, a drive mechanism of the illumination sensor 14 operates to move into a measurement position shown by long dashed double-short dashed lines.

<Step S102>

Upon completion of the input, the illumination sensor 14 is irradiated with ultraviolet rays via the diodes 11. The result of the measurement detected by the illumination sensor 14 is transmitted to the controller 56. Where the measured result does not reach the preset illuminance, an output voltage is adjusted. Where the measured result reaches the preset illuminance, measurement is completed. After completing the measurement, the illumination sensor 14 returns to its lower standby position, shown by solid lines, apart from the measurement position.

<Step S103>

The mount frame MF transported into the workpiece receiving section is suction-held by the workpiece suction mechanism 117 provided in the movable frame, and then is transported to the ultraviolet irradiation treatment section 101. The workpiece suction mechanism 117 places the ring frame f of the mount frame MF on the support board 103 in the ultraviolet irradiation treatment section 101.

<Step S104>

As shown in FIG. 10, the ultraviolet irradiation unit 12 turns, and the adhesive tape DT joined to the rear face of the mount frame MF is irradiated with ultraviolet rays via the diodes 11.

<Step S105>

The controller 56 determines whether or not ultraviolet rays have been applied to the protective tape PT for a preset period. Where ultraviolet rays have been applied for less than the preset period, further ultraviolet ray irradiation is conducted. Where ultraviolet rays have been applied for the preset period, the operation proceeds to the subsequent step.

<Step S106>

The controller 56 adjusts the output voltage of the diodes 11 with the amplifier 76, and stops ultraviolet irradiation via the diodes 11.

<Step S107>

In Step S104, the adhesive tape DT is irradiated with ultraviolet rays via the diodes 11. Simultaneously, the infrared lamp 107 below the mount frame MF applies infrared rays to heat the rear face of the adhesive tape DT.

<Step S108>

It is determined whether or not the temperature on the rear face of the supporting adhesive tape DT reaches the preset temperature. The output voltage of the infrared lamp 107 is adjusted with an amplifier, not shown, within the preset period so that the detected temperature conforms to the varying pattern on the polymerization temperature.

Here, the controller 56 determines whether or not infrared rays are applied for the preset period. Where the irradiation time of period with the infrared lamp 107 is less than the preset period, further infrared ray irradiation is conducted. Where the irradiation time of period with the infrared lamp 107 reaches the preset period while the preset temperature is maintained, the operation proceeds to the subsequent step.

<Step S109>

Upon reaching to the preset period, the controller 56 adjusts the output voltage of the infrared lamp 107 with an amplifier, not shown, thereby stopping infrared ray irradiation with the infrared lamp 107.

<Step S110>

The mount frame MF on the support board 103 in the ultraviolet irradiation treatment section 101 is moved to the workpiece ejection section. The mount frame MF ejected is transported from the workpiece ejection section to a die-bonding device.

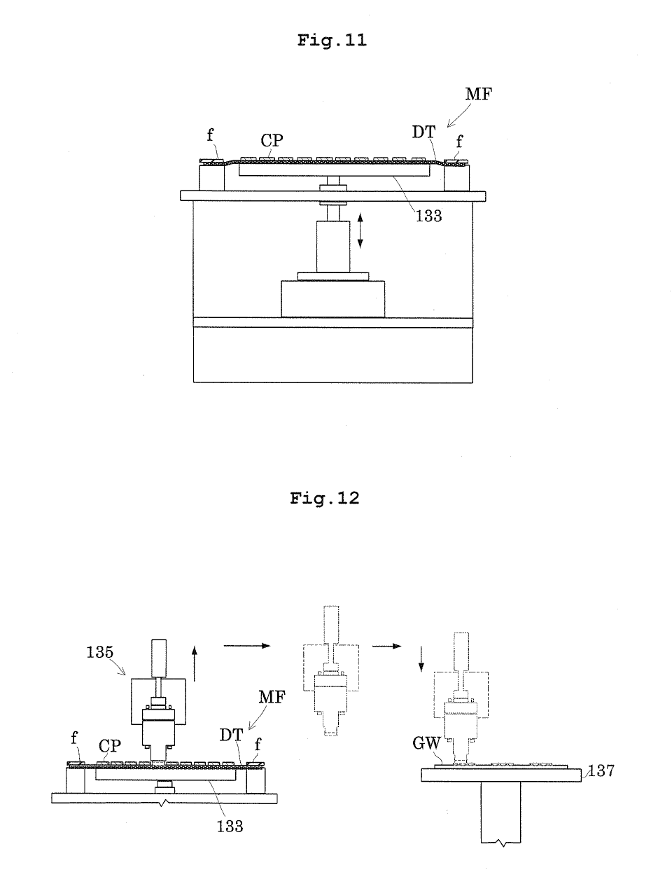

In the die-bonding device shown in FIG. 11, the mount frame MF is placed on a wafer holding table 133. The wafer holding table 133 suction-holds the entire rear face of the mount frame MF. The wafer holding table 133 moves upward to a given level for pushing up the chips CP together with the adhesive tape DT. Thereafter, the wafer holding table 133 moves downward to its original level. Spaces between the chips CP increase, whereby a head of a separation mechanism 135 may suck the chips CP with ease.

<Step S111>

The separation mechanism 135 moves downward toward the wafer holding table 133, as shown in FIG. 12. The separation mechanism 135 contacts the head thereof to the chips CP to suction-hold the chips CP. Suction-holding is confirmed, and then the tape separation mechanism 135 moves upward and horizontally to transport the chips CP to a substrate holding stage 137. Accordingly, the chips CP are separated from the adhesive tape DT.

The separation mechanism 135 reaches a substrate holding stage 137 side as shown by long dashed double-short dashed lines. Then, a sensor confirms a mount region of the chip CP on a substrate GW, and the separation mechanism 135 moves downward for mounting the chip CP to the region.

The substrate GW having the mounted chips CP is transported from the substrate holding stage 137 with a substrate transportation mechanism, not shown. Then, the substrate GW is housed in a substrate housing magazine, not shown. Thereafter, the substrate transport mechanism transports another substrate GW.

A series of operations of separating the adhesive tape DT from one chip CP are completed as noted above. The same process as above is to be repeatedly performed to every chip CP on the mount frame MF. After separation of the adhesive tape DT is completed from all chips CP on the mount frame MF, the same process as above is to be repeatedly performed to every mount frame MF housed in a cassette, not shown.

As noted above, the adhesive tape DT joined to the rear face of the mount frame MF is irradiated with ultraviolet rays via the diodes 11. Simultaneously, the infrared lamp 107 heats the adhesive tape DT to the preset temperature. Here, an ultraviolet reaction with the diodes 11 and an infrared reaction with the infrared lamp 107 may ensure promotion of a polymerization reaction that is not curable with only ultraviolet rays, which results in cure of the adhesive. Consequently, the adhesive force of the adhesion tape DT may sufficiently be reduced. After ultraviolet irradiation via the diodes 11 and heating with the infrared lamp 107, the separation mechanism 135 separates the chips CP from the adhesive tape DT. Consequently, accurate separation may be realized of the adhesive tape DT joined to the chips CP.

This invention is not limited to the foregoing embodiment, but may be modified as follows.

In each of the foregoing embodiments, the diodes 11 irradiates the protective tape PT with ultraviolet rays, and simultaneously the heater 71 heats the protective tape PT to the preset temperature. Alternatively, ultraviolet rays may be applied prior to heating of the heater 71. Ultraviolet rays may be applied after heating of the heater 71. The adhesive force of the protective tape PT may sufficiently be reduced even when timings of the ultraviolet irradiation via the diodes 11 and the heating with the heater 71 are altered. Consequently, accurate separation of the protective tape PT joined to the wafer W may be realized.

In the foregoing Embodiment 1, the heater 71 embedded in the holding table 8 heats the protective tape PT via the wafer W on the holding table 8. Alternatively, the infrared lamp may heat the protective tape PT in a non-contact manner. Moreover, in the foregoing Embodiment 1, the temperature sensor 72 embedded in the holding table 8 measures the temperature of the protective tape PT via the wafer W on the holding table 8. Alternatively, the infrared camera may measure the temperature of the protective tape PT in a non-contact manner.

In the foregoing Embodiment 1, the heater 71 and the temperature sensor 72 are arranged within the holding table 8. In addition, the infrared lamp for heating the protective tape PT and the infrared camera for measuring the temperature thereof may be arranged above the holding table 8.

In each of the foregoing embodiments, the interior of the shielding wall 51 in Embodiment 1 and the shielding plate 121 in Embodiment 2 may be maintained in an airtight condition. Then, nitrogen may be supplied to the foregoing interior in an airtight condition for ultraviolet irradiation in a state where replacement by nitrogen gas is performed for discharging interior oxygen. Accordingly, oxygen leading to prevention of the polymerization reaction may be eliminated from interior of the shielding wall 51 and shielding plate 121, which results in accelerated ultraviolet curing.

In each of the foregoing embodiments, only an irradiation time of period is determined after the ultraviolet irradiation starts via the diodes 11. Illuminance may also be determined along with the irradiation time of period. Specifically, the controller 56 may turn and move the illumination sensor 14 to a measuring position at a given time of interval. The amplifier 76 may adjust illuminance of the diodes 11 in accordance with the determined illuminance.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of separating an ultraviolet curable adhesive tape that is joined to a semiconductor wafer, comprising the steps of:
applying ultraviolet rays to the adhesive tape;
heating the adhesive tape; and
separating the adhesive tape from the semiconductor wafer after the steps of applying ultraviolet rays and heating the adhesive tape.

2. The method of separating the adhesive tape according to claim 1, wherein
the steps of applying ultraviolet rays and heating the adhesive tape are performed simultaneously.

3. The method of separating the adhesive tape according to claim 1, wherein
the step of heating the adhesive tape is performed after the step of applying ultraviolet rays

4. The method of separating the adhesive tape according to claim 1, wherein
the step of applying ultraviolet rays is performed after the step of heating the adhesive tape.

5. The method of separating the adhesive tape according to claim 1, wherein
in the step of heating the adhesive tape, the adhesive tape is heated until reaching a polymerization temperature that is determined in accordance with on a photo-polymerization initiator remaining in an adhesion layer of the manufactured adhesive tape.

6. The method of separating the adhesive tape according to claim 1, wherein
in the step of heating the adhesive tape, the adhesive tape is heated until reaching a desired value as which a varying pattern is obtained from correlation in variation between a polymerization rate of a photo-polymerization initiator remaining in an adhesion layer of the manufactured adhesive tape and a heating value upon heating of the adhesive tape.

7. The method of separating the adhesive tape according to claim 1, wherein
the adhesive tape is a protective tape for protecting a surface of the semiconductor wafer having a circuit pattern formed thereon.

8. The method of separating the adhesive tape according to claim 1, wherein
the adhesive tape is a supporting adhesive tape for supporting the semiconductor wafer and a ring frame.

9. Adhesive tape separating apparatus for separating an ultraviolet curable adhesive tape that is joined to a semiconductor wafer, comprising:
a holder for holding the semiconductor wafer;
an ultraviolet irradiation unit for irradiating the adhesive tape with ultraviolet rays;
a heater for heating the adhesive tape; and
a separation mechanism for separating the adhesive tape from the semiconductor wafer after ultraviolet irradiation by use of the ultraviolet irradiation unit and heating by use of the heater.

10. The adhesive tape separating apparatus according to claim 9, wherein
the heater is embedded in the holder for heating the adhesive tape via the semiconductor wafer held on the holder.

11. The adhesive tape separating apparatus according to claim 9, wherein
the heater heats the adhesive tape via the semiconductor wafer held on the holder in a non-contact manner.

12. The adhesive tape separating apparatus according to claim 9, further comprising:
an input unit for inputting a polymerization temperature of the adhesive tape;
a measuring device for measuring a temperature of at least one of the adhesive tape heated by use of the heater and the holder; and
a controller for controlling an output voltage of the heater so that a measured temperature measured by the measuring device is equal to the polymerization temperature inputted by the input unit.

13. The adhesive tape separating apparatus according to claim 12, wherein
the controller controls the output voltage of the heater so that the measured temperature measured by the measuring device is equal to the polymerization temperature preset in accordance with types of photo-polymerization initiators.

14. The adhesive tape separating apparatus according to claim 12, wherein
the controller controls the output voltage of the heater so that a desired value is equal to the measured temperature measured by the measuring device, a varying pattern of a polymerization temperature being obtained as the desired value from correlation in variation between a polymerization rate of a photo-polymerization initiator and a heating value upon heating of the adhesive tape.

15. The adhesive tape separating apparatus according to claim 12, wherein
the controller controls the output voltage of the heater within a given heating time of period, whereby the measured temperature by the measuring device is equal to the polymerization temperature inputted by the input unit.

16. The adhesive tape separating apparatus according to claim 15, wherein
the controller controls the ultraviolet irradiation unit as to apply ultraviolet rays within a given irradiation time of period.
